(19) United States
(12) Patent Application Publication
(10) Pub. No.: US 2025/0372686 A1
(43) Pub. Date: Dec. 4, 2025

(54) FUEL CELL

(71) Applicant: SYMBIO FRANCE, Saint-Fons (FR)

(72) Inventors: Sylvain PASSOT, Tullins (FR); Florian DUCHAMP, SAINT PRIEST (FR)

(21) Appl. No.: 18/875,361

(22) PCT Filed: Jun. 20, 2023
(86) PCT No.: PCT/EP2023/066669

§ 371 Date: Dec. 16, 2024

(30) Foreign Application Priority Data
Jun. 21, 2022 (FR) FR2206092

(51) Int. Cl. H01M 8/248; H01M 8/2475

(52) U.S. Cl. CPC H01M 8/248; H01M 8/2475

(57) ABSTRACT

This fuel cell (10) comprises a housing, a stack of electrochemical cells, a fixed end plate and a movable end plate (16) clamping the stack between them, and a guidance system (30) of the movable end plate restricting the displacement of the movable end plate perpendicular to a stacking direction (X). To control the positioning of the movable end plate, the guidance system comprises at least one compression member (32) exerting a compression force (E32) on the movable end plate, according to a compression direction (Y), two guide members (36A, 36B), fixed to the movable end plate, and two oblique abutments (38A, 38B), fixed to the housing, extending parallel to the stacking direction and oblique relative to the compression direction and relative to a centering direction (Z). Under the effect of the compression force, the guide members bear against the oblique abutments and center the movable end plate, parallel to the centering direction, relative to the housing.

The present invention relates to a fuel cell.

In the field of fuel cells, it is known to clamp a stack of electrochemical cells between two end plates, located on either side of the stack in a stacking direction, and to protect this assembly in a housing. The end plates allow to both hold the stack compressed and accommodate the connectors required for fuel cell operation, such as gas inlets.

During operation, the stack of electrochemical cells tends to expand in the stacking direction, due to ageing and thermal effects. To enable this expansion to take place without damaging the electrochemical cells, it is known to fix a first end plate relative to the housing and to make a second end plate movable relative to the housing, parallel to the stacking direction. In this way, the second end plate is movable as a function of expansion of the stack, and the compression of the stack is not increased beyond a tolerance threshold by the expansion of the stack.

It is known to use a guidance system to allow the displacement of the movable end plate parallel to the stacking direction and to prevent its displacement perpendicular to the stacking direction. However, known guidance systems are generally unsatisfactory.

For example, US-A-2009/0004533 describes a fuel cell in which the movable end plate is guided in its movement parallel to the stacking direction by guide shafts extending through openings in the housing, and in which movement of the movable end plate perpendicular to the stacking direction is prevented by direct contact of the end plate against the housing walls. Guidance by the guide shafts is hyperstatic, leading to the risk of jamming the movable end plate and making fuel cell assembly more complex. Furthermore, in such a fuel cell, it is necessary to provide an operating clearance, in other words, an empty space, between the movable end plate and the housing walls, to allow the movable end plate to be displaced parallel to the stacking direction without the risk of jamming or bowing against the housing walls. However, the presence of such an operating clearance leaves the movable end plate and the electrochemical cells free to possibly vibrate perpendicular to the stacking direction. Such vibrations are detrimental to the service life of the electrochemical cells.

Another example of guiding the movable end plate is given by CN-A-112 993 368. In a first direction, perpendicular to the stacking direction, the movable end plate is guided by runners, arranged on either side of the movable end plate and bearing against the housing walls. In addition, rails are arranged on four sides of the end plate and cooperate with spring-mounted jumpers connected to the housing walls, in order to limit the displacement of the movable end plate in the first direction as well as in a second direction perpendicular to the stacking direction and to the first direction. This approach, in addition to being complex to implement and presenting a considerable volume, allows lateral displacement of the movable end plate parallel to the second direction, since the jumpers are spring-mounted. Thus, such a fuel cell does not prevent vibrations of the movable end plate, and therefore of the electrochemical cells, in the second direction, which is detrimental to the life of the electrochemical cells.

US-A-2018/0241050, EP-A-3 018 748 and US-A-2009/280388 describe further examples of a guidance system for the movable end plate of a fuel cell.

It is to these drawbacks that the invention more particularly intends to remedy, by proposing a fuel cell allowing the displacement of the movable end plate parallel to the stacking direction, while controlling the position of the end plate perpendicular to the stacking direction.

To this end, the invention relates to a fuel cell comprising:
a housing,
a stack of electrochemical cells extending according to a stacking direction,
a fixed end plate, arranged at a first end of the stack and fixed relative to the housing,
a movable end plate, arranged at a second end of the stack and movable relative to the housing parallel to the stacking direction, the fixed and movable end plates clamping the stack between them, and
a guidance system for the movable end plate, configured to allow the displacement of the movable end plate parallel to the stacking direction and to limit displacement of the movable end plate perpendicular to the stacking direction.

According to the invention, the guidance system for the movable end plate comprises:
at least one compression member exerting a compression force on the movable end plate, relative to the housing, according to a compression direction perpendicular to the stacking direction,
two guide members, fixed relative to a first element from among the housing and the movable end plate, and
two oblique abutments, fixed relative to a second element from among the housing and the movable end plate different from the first element, extending parallel to the stacking direction, each oblique abutment being oblique relative to the compression direction and relative to a centering direction perpendicular to the stacking direction and to the compression direction.

In addition, under the effect of the compression force exerted by the compression member, each guide member bears against one of the two oblique abutments and the two guide members center the movable end plate, parallel to the centering direction, relative to the housing.

Thanks to the invention, the position of the movable end plate perpendicular to the stacking direction is constrained by the guide members brought into abutment against the oblique abutments by the compression member. The oblique abutments, by being oblique relative to the direction according to which the compression forces are exerted, allows the oblique abutments both to prevent displacement of the movable end plate according to the compression direction and to center the movable end plate according to the centering direction.

According to advantageous, but not mandatory, aspects of the invention, the fuel cell incorporates one or more of the following features, taken alone or in any technically permissible combinations:
Under the effect of the compression force exerted by the compression member, a first guide member tends to cause a displacement of the movable end plate according to the centering direction, and the second guide member tends to cause a displacement of the end plate opposite to the centering direction.
Each oblique abutment is formed by a face of a rail extending parallel to the stacking direction.
Each oblique abutment is inclined relative to the compression direction at an angle of between 30° and 60°, preferably equal to 45°.
The guide members are runners presenting profiles complementary to the profiles of the oblique abutments.
The compression member is an elastically deformable blade.
The elastically deformable blade presents two ends and a central part, the two ends of the elastically deformable blade are connected to the first element, and the central part of the elastically deformable blade bears against the second element.
The elastically deformable blade extends according to a direction parallel to the stacking direction, the guidance system comprises two fixing members, and each fixing member connects one end of the elastically deformable blade to the first element, allowing displacement of this end parallel to the stacking direction and preventing displacement of this end perpendicular to the stacking direction.
The abutment of a first guide member on a first oblique abutment generates a first reaction force, the bearing of the second guide member on the second oblique abutment generates a second reaction force, each of the first and second reaction forces has a first component directed parallel to the compression direction and a second component directed parallel to the centering direction, the first components of the first and second reaction forces are equal in magnitude and orientation and opposite in orientation to the compression force, and the second components of the first and second reaction forces are equal in magnitude and opposite in orientation.
The guidance system further comprises two lateral compression members, a first lateral compression member exerting a compression force on the movable end plate relative to the housing, according to the centering direction, and the second lateral compression member exerting a compression force on the movable end plate relative to the housing opposite to the centering direction.
The fuel cell further comprises a clamping system exerting a clamping force on the movable end plate, relative to the housing, parallel to the stacking direction, tending to compress the stack of electrochemical cells.

The invention will be better understood, and other advantages of the invention will become clearer in the light of the following description of an embodiment of a fuel cell, in accordance with its principle, given by way of example only and made with reference to the appended drawings in which:

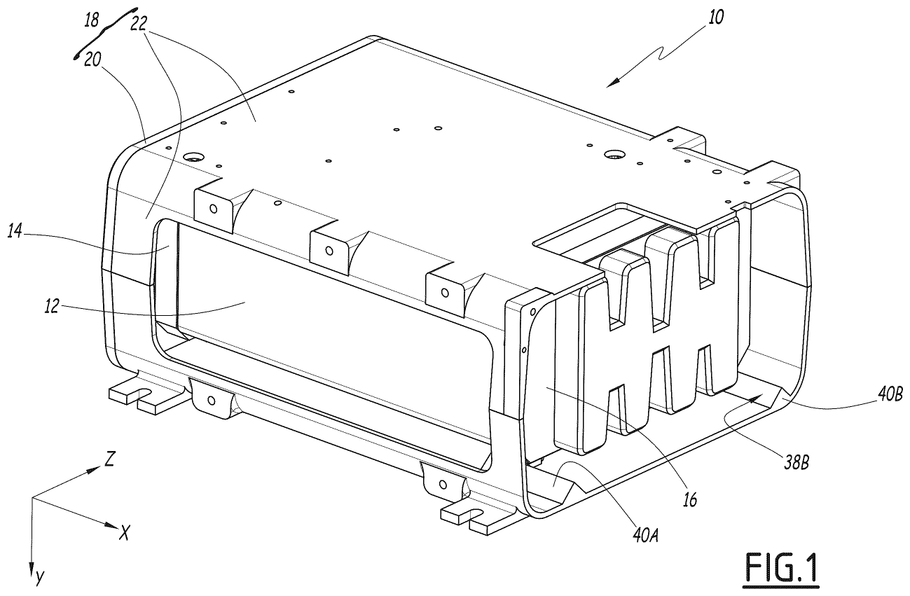

FIG. 1 is a perspective view of a fuel cell in accordance with the invention;

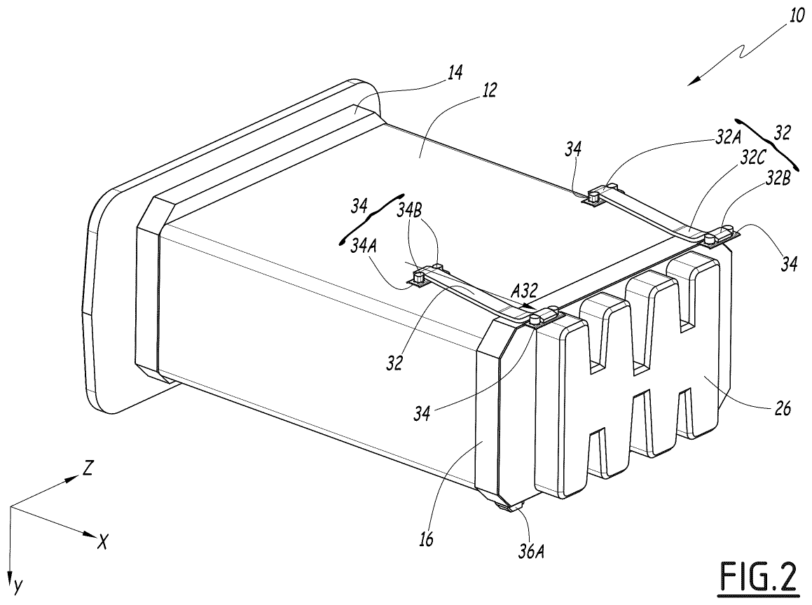

FIG. 2 is a view similar to FIG. 1, in which a housing of the fuel cell is not represented;

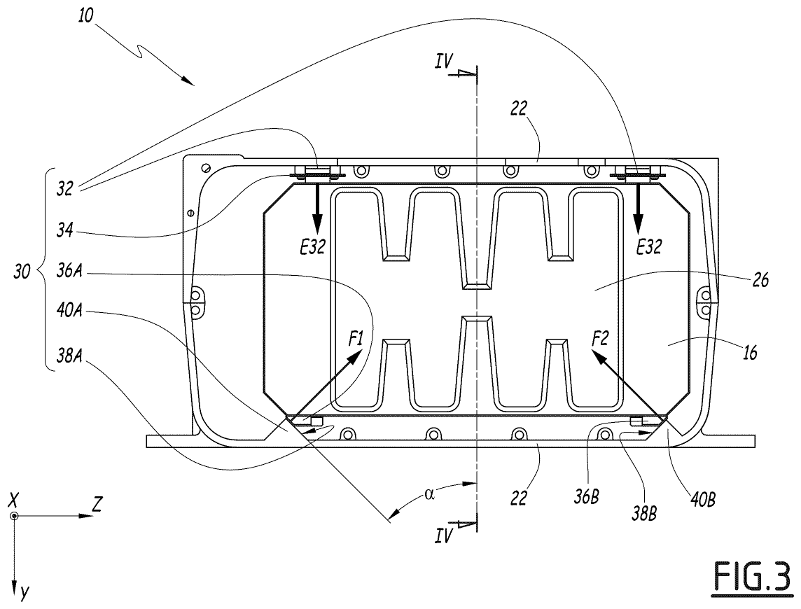

FIG. 3 is a front view of the fuel cell of FIG. 1; and

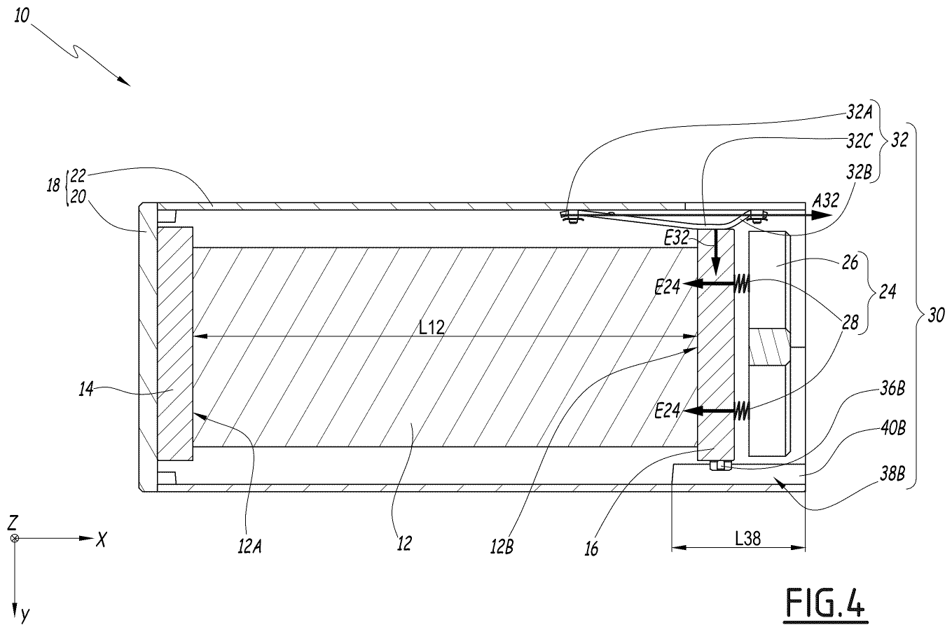

FIG. 4 is a cross-section according to the plane IV of the fuel cell in FIG. 3.

A fuel cell 10 can be seen in FIGS. 1 to 4. The fuel cell 10 is, for example, intended to be integrated into a vehicle with an electric motor in order to produce electrical energy allowing the operating of the motor, possibly in whole or in part by means of an electrical storage battery.

The fuel cell 10 comprises a stack 12 of electrochemical cells, which are not represented individually for the sake of simplicity. Each electrochemical cell is generally constituted of an anode and a cathode separated by a polymer membrane allowing protons to pass from the anode to the cathode. The anode is supplied with fuel, for example dihydrogen, and the cathode with oxidant, for example oxygen or air.

The electrochemical cells are stacked according to a stacking direction X to form the stack 12. The stacking direction X is that of the length of the stack 12, in other words, the longitudinal direction of this stack. Preferably, when the fuel cell 10 is in operation, for example in a vehicle, the stacking direction X is horizontal.

In the present description, the term direction is used as the direction of orientation of a straight line in a plane. In other words, a direction corresponds to an oriented straight line, and therefore to a direction of travel along this line.

The fuel cell 10 comprises a fixed end plate 14 and a movable end plate 16, which are arranged on either side of the stack 12, according to the stacking direction X. In the example, the stacking direction X is oriented so as to extend from the fixed end plate 14 toward the movable end plate 16. In practice, the fixed end plate 14 and the movable end plate 16 extend perpendicularly to the stacking direction X.

In practice, the fixed end plate 14 is arranged at a first end 12A of the stack 12 and the movable end plate 16 is arranged at a second end 12B of the stack, which corresponds to a free end of the stack. In other words, the movable end plate 16 forms a free end of the assembly formed by the fixed and movable end plates and the stack 12.

Preferably, the fixed end plate 14 includes connectors, not represented, provided to be connected to fluid circulation ducts, thus allowing the stack 12 to be supplied with fuel and oxidant gases, and possibly with cooling fluid. In a manner known per se, other elements can be interposed between each of the end plates 14, 16 and the stack. In a non-limiting manner, these may include, for example, a current collector plate and/or an insulator plate.

The fuel cell 10 comprises a housing 18, which surrounds and protects the electrochemical cell stack 12. In practice, the housing 18 comprises a base 20 and lateral walls 22. Here, the base 20 is perpendicular to the stacking direction X and the lateral walls 22 extend parallel to the stacking direction X.

The fixed end plate 14 is, in practice, fixed to the housing 18, more precisely to the base 20 of the housing, and the movable end plate 16 is movable in the housing parallel to the stacking direction X, between the lateral walls 22, as detailed below. The base 20 of the housing and the fixed end plate 14 thus form a rigid assembly. In the example, the base of the housing and the fixed end plate are two separate parts rigidly connected to each other. In one alternative of the invention, not represented, the base of the housing and the fixed end plate are formed in a single piece, in which case the two are merged.

The fuel cell 10 comprises a clamping system 24 exerting a clamping force E24 on the movable end plate 16, relative to the housing 18. This clamping force E24 is parallel to and in the opposite direction to the stacking direction X, which is a longitudinal direction of the stack. The clamping force E24 is therefore a longitudinal compression force exerted on the movable end plate 16. The longitudinal direction X is therefore a clamping direction of the stack 12. The clamping system 24 tends to bring the movable end plate 16 closer to the fixed end plate 14, thus compressing the stack 12 between the fixed and the movable end plates. In other words, the fixed and the movable end plates clamp the stack 12 between them under the effect of the clamping force E24. Compression of the stack 12 between the fixed 14 and the movable 16 end plates ensures optimum operation of the electrochemical cells, and therefore of the fuel cell 10.

In the example, the clamping system 24 comprises a clamping flange 26 and compression springs 28 arranged between the clamping flange 26 and the movable end plate 16, for example four or nine compression springs. The compression springs 28 are compressed so as to exert the clamping force E24 on the movable end plate 16, relative to the clamping flange 26, thus compressing the stack 12. Here, the clamping flange 26 is fixed relative to the housing 18, for example by being fixed to the lateral walls 22 using fixing means, not represented. For the sake of simplicity, the compression springs 28 are represented only in FIG. 4. The clamping force E24 is divided into several elementary forces, each of which is exerted by a compression spring, two of which are represented in FIG. 4.

Other designs for the clamping system 24 are also possible. According to a first alternative, not represented, the clamping flange 26 may not be fixed to the lateral walls 22 of the housing 18, but connected to the base 20 of the housing by means of tie rods, allowing the displacement of the clamping flange perpendicular to the stacking direction X while preventing the displacement of the clamping flange parallel to the stacking direction X. Furthermore, in the event of high thermal stresses being applied to the fuel cell 10, the tie rods may also tend to expand according to the stacking direction X, causing a displacement of the clamping flange 26 according to the stacking direction X.

According to another alternative, not represented, the clamping system 24 comprises tension springs instead of the clamping flange and compression springs, which are fixed to the base 20 of the housing 18 on the one hand, and to the movable end plate 16 on the other.

Over the life of the fuel cell 10, the stack 12 of electrochemical cells tends to expand and/or contract, parallel to the stacking direction X. This variation in the length of the stack 12 is caused, for example, by the ageing of the electrochemical cells, by the build-up of fluid pressure in the channels of the electrochemical cells of the stack 12, or by thermal effects. In practice, the dimensional variation of the stack 12 is small relative to the length of the stack, noted L12. The maximum dimensional variation of the stack 12 is thus, for example, equal to a percentage in the range from 0.5% to 2% of the stack length L12. For example, for a length L12 of the stack 12 of the order of 400 mm, measured in stacking direction X, the maximum dimensional variation of the stack over its lifetime is of the order of a few millimeters, for example 4 mm.

As the end plate 14 is fixed relative to the housing 18, any variation in the length of the stack 12 results in a displacement of the movable end plate 16, parallel to the stacking direction X.

In practice, for example, the compression springs 28 are dimensioned so as to absorb the maximum dimensional variation of the stack 12, while maintaining a clamping force the variation of which is small enough to remain within a stack clamping force tolerance range, whatever the expansion or contraction of the stack.

To allow the displacement of the movable end plate 16 parallel to the stacking direction X while limiting a displacement of the movable end plate perpendicular to the stacking direction, the fuel cell 10 comprises a guidance system 30.

A transverse direction Y of the fuel cell 10 is defined as a direction perpendicular to the stacking direction X, and a centering direction Z of the fuel cell is defined as a direction perpendicular to the stacking direction X and the transverse direction Y. Preferably, when the fuel cell 10 is in operation, for example in a vehicle, with the stacking direction X horizontal, the transverse direction Y is vertical, and advantageously oriented downward, and the centering direction Z is horizontal. Here, the centering direction Z is arbitrarily defined as oriented, from the point of view of FIG. 3, from left to right, and the directions X, Y and Z are those of the axes of an orthogonal reference frame.

The guidance system 30 comprises at least one compression member 32, which exerts a compression force E32 on the movable end plate 16, relative to the housing 18, in the transverse direction Y. The transverse direction is therefore a compression direction of the movable end plate 16, perpendicular to the compression direction X of the stack 12. In other words, the compression force E32 is transversal relative to the stack 12.

In the example, the guidance system 30 comprises two compression members 32, each exerting a compression force E32 on the movable end plate 16. Alternatively, the guidance system 30 comprises a different number of compression members 32, for example a single compression member or three compression members.

A compression member 32 is, for example, in the form of an elastically deformable blade, one portion of which, for example one end, is fixed to one from among the housing 18 and the movable end plate 16, and one portion of which bears against the other from among the housing and the movable end plate. Here, the compression members 32 are elastically deformable blades. In the example, each elastically deformable blade 32 presents a first end 32A, a second end 32B and a central part 32C. Each elastically deformable blade 32 extends according to a direction A32 generally parallel to the stacking direction X and presents a domed profile according to the compression direction Y, in other words, according to the compression direction Y of the movable end plate 16, the first end 32A is aligned with the second end 32B but the central part 32C is not aligned with the first and second ends 32A, 32B. The direction A32 is shown only in FIG. 2, for one of the two elastically deformable blades 32.

In the example, the elastically deformable blades 32 are deformable metal blades. Alternatively, the elastically deformable blades can be made of another material, such as a polymer or composite.

In the example, the first and second ends 32A, 32B are connected to the housing 18, in practice to one of the lateral walls 22 of the housing, and the central part 32C bears against the movable end plate 16.

In practice, the guidance system 30 comprises, for each metal blade 32, two fixing members 34. Preferably, each fixing member 34 connects one of the two ends 32A, 32B of a metal blade 32 to the housing 18, so as to allow a displacement of this end parallel to the stacking direction X while preventing a displacement of this end perpendicular to the stacking direction X.

Here, each fixing member 34 comprises a retaining plate 34A and two retaining elements 34B. The retaining plate 34A extends parallel to the lateral wall 22 of the housing 18 to which the ends of the metal blades are connected, in other words, it extends parallel to the centering direction Z and the stacking direction X, and is fixed to the lateral wall of the housing by the two retaining elements 34B, which, in the example, are screws. The two screws 34B are aligned according to the stacking direction X and offset from each other parallel to the centering direction Z. When the fuel cell 10 is assembled, each end 32A, 32B of each metal blade 32 is arranged, parallel to the compression direction Y, between a lateral wall 22 of the housing 18 and the retaining plate 34A of a fixing member 34, and, parallel to the centering direction Z, between the two screws 34B of this fixing member 34. Thus, the displacement of each end of each metal blade parallel to the compression direction Y and the centering direction Z is prevented.

In addition, the fixing members 34 allow a displacement of the metal blades 32 parallel to the stacking direction X. In practice, the permitted displacement of a metal blade 32 parallel to the stacking direction X is small, due to the domed shape of the metal blades, since in the event of too great a displacement, the metal blade comes into contact with the retaining plate 34A of one of the fixing members 34, thus preventing further displacement of the metal blade.

Alternatively, each fixing member 34 fixes one of the two ends 32A, 32B of a metal blade 32 to the housing 18, preventing any displacement of this end in the three directions X, Y and Z.

When the fuel cell 10 is assembled, each metal blade 32 is constrained between the housing 18 and the movable end plate 16, in other words, each metal blade is elastically deformed to be positioned between the housing and the end plate. This constraint of the metal blades 32 is facilitated by the ability of the ends 32A and 32B of the metal blades to displace parallel to the stacking direction X. In practice, the constraining of a metal blade 32 generates a reaction force on the housing 18 and on the movable end plate 16, and thus generates a compression force E32. The metal blades 32 therefore act as compression springs.

Preferably, all the compression forces E32 exerted by the metal blades 32 are identical, within manufacturing and assembly tolerances.

The use of metal blades 32 to exert the compression force E32 on the movable end plate 16 is advantageous, as the metal blades are elongated in the direction of movement of the movable end plate, in other words, parallel to the stacking direction X. Thus, the metal blades 32, and more particularly their central part 32C, maintain contact with the movable end plate 16 independently of the position of the movable end plate according to the stacking direction X, within the limit of the expansion amplitude of the stack 12. The compression force E32 is therefore maintained on the movable end plate 16 throughout the life of the fuel cell 10.

In one alternative of the invention, not represented, the metal blades 32 are reversed, in other words, their ends 32A, 32B are fixed to the movable end plate 16 and their central part 32C is bearing against the housing 18. Preferably, in such an alternative, the movable end plate 16 comprises a skirt extending parallel to the stacking direction X, allowing the two ends of the metal blades to be connected to it.

In one alternative of the invention, not represented, other compression members are used instead of the metal blades, such as coil springs or spring washers, known as “Belleville washers”. The compression members can also each be formed by a compression member comprising one or more coil springs and/or one or more spring washers in conjunction with a deformable blade, in particular with a deformable blade such as described above, or with an articulated blade, one end of which is fixed to one from among the housing 18 and the movable end plate 16, one portion of which bears on the other one from among the housing and the movable end plate, and another portion of which serves as an abutment for the one or more coil springs and/or the one or more spring washers.

The guidance system 30 further comprises two guide members 36A, 36B and two oblique abutments 38A, 38B extending parallel to the stacking direction X.

The guide members 36A, 36B are, in the example, fixed to the movable end plate 16, opposite the metal blades 32, according to the compression direction Y. In other words, the metal blades 32 and the guide members 36A, 36B are located at two opposite edges of the end plate 16. In addition, the guide members 36A and 36B are preferably arranged symmetrically relative to each other, relative to the cross-sectional plane IV, which is a median plane of the fuel cell parallel to the directions X and Y.

The oblique abutments 38A and 38B are, in the example, fixed to the housing 18, and more precisely on the lateral wall 22 of the housing opposite the lateral wall to which the metal blades 32 are connected. Thus, in the example where the stacking direction is horizontal and the compression direction is vertical and directed downward, the oblique abutments 38A and 38B are located underneath the movable end plate 16. In practice, the oblique abutments 38A and 38B are oblique relative to the compression direction Y and relative to the centering direction Z. In other words, a straight line normal to the oblique abutments 38A and 38B intersects the directions of compression Y and centering Z. Furthermore, the oblique abutment 38A is symmetrical to the oblique abutment 38B, relative to the compression direction Y, so that a line normal to the oblique abutment 38A is perpendicular to a line normal to the oblique abutment 38B.

When the fuel cell 10 is assembled, under the effect of the compression forces E32 generated by the metal blades 32, which cause a displacement of the end plate 16 in the compression direction Y, the guide member 36A is brought to bear against the oblique abutment 38A and the guide member 36B is brought to bear against the oblique abutment 38B. Thus, the oblique abutment 38A exerts a reaction force F1 on the guide member 36A, directed perpendicularly to the oblique abutment 38A, and the oblique abutment 38B exerts a reaction force F2 on the guide member 36B, directed perpendicularly to the oblique abutment 38A.

The reaction forces F1 and F2 are oriented perpendicularly to the stacking direction X and obliquely to the compression direction Y and the centering direction Z. Furthermore, the reaction force F1 is symmetrical to the reaction force F2, relative to the compression direction Y. In other words, the reaction forces F1 and F2 each have a first component directed parallel to the compression direction Y and a second component directed parallel to the centering direction Z, the first components of the reaction forces F1 and F2 are of equal intensity and orientation, and the second components of the reaction forces F1 and F2 are of equal intensity and opposite orientation.

It is thus understood that the reaction force F1 tends to cause a displacement of the movable end plate 16 according to the centering direction Z and that the reaction force F2 tends to cause a displacement of the movable end plate 16 opposite to the centering direction Z. These two opposing forces cause the movable end plate 16 to be centered relative to the oblique abutments 38A, 38B, parallel to the centering direction Z. Advantageously, the oblique abutments 38A and 38B are themselves centered relative to the fixed end plate 14. Under the effect of the reaction forces F1 and F2, the movable end plate 16 is centered relative to the fixed end plate 14, parallel to the centering direction Z.

In addition, and in a particularly advantageous manner, the oblique abutments 38A and 38B converge away from the wall 22 of the housing 18 to which the metal blades 32 are connected, in other words, a normal vector to the oblique abutment 38A and a normal vector to the oblique abutment 38B converge toward each other. Thus, the second components of the reaction forces F1 and F2 converge. The centering of the movable end plate 16 is thus improved.

In one alternative of the invention, not represented, the oblique abutments 38A and 38B diverge away from the wall 22 of the housing 18 to which the metal blades 32 are connected, in other words, a normal vector to the oblique abutment 38A and a normal vector to the oblique abutment 38B diverge from each other, and the second components of the reaction forces F1 and F2 diverge.

Furthermore, the sum of the compression forces E32 and the reaction forces F1 and F2 is zero, so that, once the guide members 36A, 36B are pressed against the two oblique abutments 38A, 38B by the compression members, these forces do not cause any displacement of the movable end plate 16, relative to the housing 18, perpendicular to the stacking direction X. In other words, the compression force E32 and the reaction forces F1 and F2 constrain the position of the movable end plate 16 relative to the housing 18, perpendicular to the stacking direction X.

Thus, in a particularly advantageous manner, the compression forces E32 and the reaction forces F1, F2 constrain the position of the movable end plate 16 parallel to the compression direction Y, so as to press the guide members 36A, 36B against the oblique abutments 38A, 38B, in other words, by displacing the movable end plate 16 as far as possible in the compression direction Y. Similarly, the compression force E32 and the reaction forces F1, F2 constrain the position of the movable end plate 16 parallel to the centering direction Z, centering the movable end plate relative to the fixed end plate 14, in other words, relative to the housing 18.

This abutment of the movable end plate 16 in the direction Y and this centering of the movable end plate relative to the housing 18, and therefore relative to the fixed end plate 14, parallel to the centering direction Z, are particularly advantageous to avoid deformation of the stack 12 and to avoid vibrations of the stack 12, likely to damage the electrochemical cells. This increases the service life of the fuel cell 10.

In practice, the guidance system 30 limits any displacement of the movable end plate 16 in the compression direction Y as well as parallel to the centering direction Z, thanks to the abutment of the guide members 36A, 36B against the oblique abutments 38A, 38B. Furthermore, since the compression force E32 and the reaction force F1, F2 are perpendicular to the stacking direction X, the guidance system 30 does not oppose the displacement of the movable lateral plate parallel to the stacking direction X.

In addition, the guidance system 30 limits any displacement of the movable end plate 16 in the opposite direction to the compression forces E32, in other words, in the opposite direction to the compression direction Y, in other words, upward in the example in FIG. 3, thanks to the compression forces E32 generated by the metal blades 32. Thus, a displacement of the movable end plate 16 opposite to the compression direction Y is theoretically possible, but such a displacement must be caused by a force on the movable end plate directed opposite to the compression direction Y, in other words, opposite to the compression forces E32, and of greater intensity than the compression forces E32. In practice, during normal use of the fuel cell 10, for example in a vehicle, the forces experienced by the movable end plate 16 come essentially from vehicle vibrations, and their intensity is less than the compression forces E32. Thus, in normal use of the fuel cell 10, the metal blades 32 are advantageously dimensioned to exert compression forces E32 on the movable end plate 16 sufficient to prevent the displacement of the movable end plate 16 according to the direction of compression Y. By way of example, a sum of the compression forces E32, approximately equal to 1000 N, allows any upward vertical displacement of the movable end plate 16 to be avoided, under normal operating conditions of the fuel cell 10, in other words, as long as the accelerations undergone by the movable end plate parallel to the compression direction Y are less than 15 g, with “g” expressing the acceleration of standard gravity.

In addition, the fact that the compression direction Y is preferentially oriented vertically and that the compression forces E2 are directed downward according to this vertical direction means that a vertical upward displacement of the movable end plate 16 is also limited by the own weight of the movable end plate and the stack 12, which adds to the compression forces E32 to limit the vertical upward displacement of the movable end plate.

It is advantageous that the oblique abutments 38A, 38B extend parallel to the stacking direction X, as the contact between the oblique abutments and the guide members 36A, 36B is thus maintained independently of the expansion of the stack 12. In practice, the oblique abutments 38A and 38B extend over a length L38 at least equal to the maximum amplitude of expansion of the stack 12.

In practice, the oblique abutments 38A and 38B are inclined relative to the compression direction Y by an angle α of between 30° and 60°. Preferably, the oblique abutments 38A and 38B are inclined at 45° relative to the compression direction Y, and therefore also inclined at 45° to the centering direction Z. Thus, for each of the reaction forces F1 and F2, the first component is equal in intensity to the second component. This configuration is advantageous for balancing the forces exerted on the movable end plate 16 parallel to the compression direction Y with the forces exerted on the movable end plate 16 parallel to the centering direction Z.

Thanks to the guidance system 30, the position of the movable end plate 16 is rigidly constrained parallel to the compression direction Y and the centering direction Z. Movements of the movable end plate according to these directions are thus virtually eliminated, when the fuel cell is in operation, reducing mechanical stress on the electrochemical cells of the stack 12 and thus increasing their service life. Advantageously, under normal operating conditions of the fuel cell 10, the guidance system 30 prevents the displacement of the movable end plate 16 parallel to the compression direction Y and the centering direction Z. In other words, thanks to the guidance system 30, the movable end plate 16 is movable parallel to the stacking direction X relative to the housing 18 according to a sliding connection, under normal operating conditions of the fuel cell 10.

One advantage of the guidance system 30 is to allow, thanks to the oblique abutments 38A, 38B which are oblique relative to the compression direction Y and the centering direction Z, to constrain the displacement of the movable end plate 16 both parallel to the compression direction Y and parallel to the centering direction Z, by exerting compression forces on the movable end plate only in the compression direction Y, with the aid of the metal blades 32. The design of the guidance system 30 is thus particularly simple, reducing the manufacturing cost of the fuel cell 10.

A further advantage of the guidance system 30 is that forces are exerted only on the movable end plate 16 and on the housing 18, and no forces are exerted on the stack 12. The stack 12 is thus suspended between the fixed end plate 14 and the movable end plate 16, and the mechanical forces exerted on the electrochemical cells are reduced.

Advantageously, but not mandatory, the fuel cell 10 is integrated into a vehicle by being connected to a chassis of this vehicle by means of a damping device, such as, for example, by means of springs and/or elastomeric studs, which are advantageously provided in this case between the housing 18 and the vehicle chassis. In particular, such a damping device allows to limit the vibrations to which the fuel cell is subjected. It is particularly advantageous to dampen the relative movements of the fuel cell relative to the vehicle chassis in order to reduce the mechanical constraints exerted on the fuel cell 10 in general, and on the electrochemical cells of the stack 12 in particular. Such a damping device is also particularly suitable for use with the guidance system 30 of the invention, since the damping device reduces the mechanical stresses exerted on the fuel cell and the guidance system allows that the mechanical constraints remaining after damping do not lead to displacement of the movable end plate 16, relative to the housing 18, likely to damage the electrochemical cells of the stack 12.

In the example, the two guide members 36A, 36B are two shoes, which are fixed to the movable end plate 16, and the two oblique abutments 38A, 38B are formed by the faces of two rails 40A, 40B fixed to, or integral with, the housing 18, and more precisely with one of the lateral walls 22 of the housing. The shoes 36A, 36B present profiles complementary to the profiles of the oblique abutments 38A, 38B in order to allow optimum contact between the shoes and the oblique abutments.

Advantageously, but not mandatory, the shoes 36A, 36B can be constituted of or coated with a material with low-friction properties, such as, for example, polytetrafluoroethylene, also known by the trade name “Teflon”, or can be constituted of materials with surface conditions ensuring a low coefficient of friction.

Here, the two rails 40A and 40B extend parallel to each other and parallel to the stacking direction X and present a triangular profile. The oblique abutments 38A, 38B are therefore flat surfaces. In the example, the oblique abutments 38A and 38B are formed by faces of rails 40A, 40B the normal surface of which is oriented toward the center of the movable end plate 16, as seen in FIG. 3.

In one alternative of the invention, not represented, the oblique abutments are formed by the faces of the rails 40A, 40B oriented toward the exterior of the movable end plate. Thus, the oblique abutments 38A and 38B diverge away from the wall 22 of the housing 18 to which the metal blades 32 are connected.

In one alternative of the invention, not represented, the two oblique abutments 38A and 38B are formed on two separate faces of the same rail.

In one alternative of the invention, not represented, the rails 40A, 40B present a profile other than a triangular profile, such as for example, a trapezoidal profile or a profile in the shape of any quadrilateral presenting at least one oblique face so as to form an oblique abutment 38A, 38B.

In one alternative of the invention, not represented. the oblique abutments 38A, 38B are not flat, but present another profile, for example an arcuate or elliptical profile, this profile being seen perpendicular to the stacking direction X and extending according to the stacking direction. In such an alternative, the shape of the guide members 36A, 36B is adapted to match the profile of the oblique abutments 38A, 38B. For example, the guides are ball shaped.

In one alternative of the invention, not represented, the guide members 36A, 36B are fixed to the housing 18 and the rails 40A, 40B forming the oblique abutments 38A, 38B are fixed to the movable end plate 16.

In one alternative of the invention, not represented the positioning of the compression members 32, on the one hand, and the guide members 36A, 36B and the oblique abutments 38A, 38B, on the other hand, are reversed. In such an alternative, the compression direction Y is vertical and directed upward.

In practice, the fuel cell 10 can also be implemented with other orientations for the stacking direction X, the compression direction Y and the centering direction Z. For example, the stacking direction can be vertical, or the centering direction Z can be vertical.

In one alternative of the invention, not represented, the guidance system 30 also comprises two lateral compression members, arranged on either side of the movable end plate 16, parallel to the centering direction Z, which exert compression forces on the movable end plate parallel to the centering direction. Thus, a first of the two lateral compression members exerts a compression force on the movable end plate 16, relative to the housing 18, according to the centering direction Z, and a second of the two lateral compression members exerts a compression force on the movable end plate, relative to the housing, opposite to the centering direction. In such an alternative, the centering of the movable end plate relative to the fixed end plate 14 is reinforced.

Any feature described for one embodiment or an alternative in the foregoing may be implemented for the other embodiments and alternatives described above, insofar as technically feasible.

1-11. (canceled)

12. A fuel cell comprising:
a housing,
a stack of electrochemical cells extending according to a stacking direction,
a fixed end plate, arranged at a first end of the stack and fixed relative to the housing,
a movable end plate, arranged at a second end of the stack and movable relative to the housing, parallel to the stacking direction, the fixed end plate and the movable end plate clamping the stack between them, and
a guidance system for the movable end plate, configured to allow displacement of the movable end plate parallel to the stacking direction and to limit displacement of the movable end plate perpendicular to the stacking direction,
wherein the guidance system for the movable end plate comprises:
at least one compression member exerting a compression force on the movable end plate, relative to the housing, according to a compression direction perpendicular to the stacking direction,
two guide members, fixed relative to a first element from among the housing and the movable end plate, and
two oblique abutments, fixed relative to a second element from among the housing and the movable end plate different from the first element, extending parallel to the stacking direction, each oblique abutment being oblique relative to the compression direction and relative to a centering direction perpendicular to the stacking direction and to the compression direction,
and wherein, under effect of the compression force exerted by the compression member, each guide member is bearing against one of the two oblique abutments and the two guide members center the movable end plate, parallel to the centering direction, relative to the housing.

13. The fuel cell according to claim 12, wherein, under effect of the compression force exerted by the compression member, a first of the two guide members tends to cause a displacement of the movable end plate according to the centering direction, and a second of the two guide members, distinct from the first, tends to cause a displacement of the end plate opposite to the centering direction.

14. The fuel cell according to claim 12, wherein each oblique abutment is formed by a face of a rail extending parallel to the stacking direction.

15. The fuel cell according to claim 12, wherein each oblique abutment is inclined relative to the compression direction by an angle of between 30° and 60°.

16. The fuel cell according to claim 15, wherein the angle is equal to 45°.

17. The fuel cell according to claim 12, wherein the guide members are shoes presenting profiles complementary to profiles of the oblique abutments.

18. The fuel cell according to claim 12, wherein the compression member is an elastically deformable blade.

19. The fuel cell according to claim 18, wherein the elastically deformable blade presents two ends and a central part, wherein the two ends of the elastically deformable blade are connected to the first element, and wherein the central part of the elastically deformable blade is bearing against the second element.

20. The fuel cell according to claim 19, wherein the elastically deformable blade extends according to a direction parallel to the stacking direction, wherein the guidance system comprises two fixing members, and wherein each fixing member connects one end of the elastically deformable blade to the first element, allowing a displacement of this end parallel to the stacking direction and preventing a displacement of this end perpendicular to the stacking direction.

21. The fuel cell according to claim 12, wherein the abutment of a first of the two guide members on a first of the two oblique abutments generates a first reaction force, wherein the abutment of a second of the two guide members, distinct from the first, on a second of the two oblique abutments, distinct from the first, generates a second reaction force, wherein each of the first and second reaction forces has a first component directed parallel to the compression direction and a second component directed parallel to the centering direction, wherein the first components of the first and second reaction forces are of equal intensity and orientation and of opposite orientation to the orientation of the compression force, and wherein the second components of the first and second reaction forces are of equal intensity and opposite orientation.

22. The fuel cell according to claim 12, wherein the guidance system further comprises two lateral compression members, a first of the two lateral compression members exerting a compression force on the movable end plate, relative to the housing, according to the centering direction, and a second of the two lateral compression members, distinct from the first, exerting a compression force on the movable end plate, relative to the housing, opposite to the centering direction.

23. The fuel cell according to claim 12, wherein the fuel cell further comprises a clamping system exerting a clamping force on the movable end plate, relative to the housing, parallel to the stacking direction, tending to compress the stack of electrochemical cells.
